(19) United States
(12) Patent Application Publication
(10) Pub. No.: US 2010/0002274 A1
(43) Pub. Date: Jan. 7, 2010

(54) INDEPENDENT SCANNING APPARATUS AND INDEPENDENT SCANNING METHOD

(75) Inventors: Chun Jen Lee, Taoyuan (TW); Chien Hsing Tang, Taoyuan (TW); Te Yuan Li, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Qisda Corporation, Taoyuan (TW)

(21) Appl. No.: 12/497,971

(22) Filed: Jul. 6, 2009

(30) Foreign Application Priority Data
Jul. 4, 2008 (TW) 097125267

(51) Int. Cl. H04N 1/04

(52) U.S. Cl. 358/498

(57) ABSTRACT

The invention discloses an independent scanning apparatus and an independent scanning method. The independent scanning apparatus of the invention includes a casing, a sheet-feeding mechanism, a scanning device, a store module, and a processing module. The casing includes an inlet and an outlet. The sheet-feeding mechanism is disposed in the casing for transporting an object through the inlet and the outlet. The scanning device is disposed in the casing for scanning the object. The processing module is disposed in the casing and electrically connected to the sheet-feeding mechanism, the scanning device and the store module. When the object enters the casing through the inlet and the independent scanning apparatus receives an actuation instruction, the sheet-feeding mechanism transport the object from a first position toward the outlet and the scanning device starts to scan the object to generate scanned image data which is then stored in the store module, and when the object arrives at a second position, the scanning device stops the scanning. A modified image data could be determined according to the analysis of the scanned image data.

### BACKGROUND OF THE INVENTION

1. Field of the Invention

This invention relates to an independent scanning apparatus and an independent scanning method and more particularly relates to an independent scanning apparatus and an independent scanning method which are capable of modifying scanned images.

2. Description of the Prior Art

A known scanner, for example, of flatbed type, auto document feeder type, roller type and so on, obtains data by scanning and sends it to an external computer (through a USB interface) for further processing. The scanning system is therefore too huge to be carried, and it is inconvenient for a user to operate that the scanning operation is performed by the computer at a place and the document is to be scanned by the scanner at another place.

Although the present personal computer has many powerful functions to satisfy users' various requirements, only some of the functions are often used for users' practical applications. Especially when the users just need a few, even single function, the known scanning system architecture (a scanner plus a computer) looks quite huge and complicated to operate.

For an example of a request for repairs to a photograph, the photograph to be repaired has to be scanned first by a scanner so as to obtain scanned image data which is then transmitted to a computer. The computer performs repairs through software executed on the computer according to the scanned image data. When the above process is performed by the known scanning system, the user has to move to the computer to operate the repair software for the repairs after the photograph is scanned. Obviously, the above process cannot be performed at any place ad lib.

In addition, except the flatbed type, if a multi-scanning is required, a sheet is re-fed manually for other known scanners. However, the relative positions of two contiguous scanning could not be controlled precisely so that it is not easy to simplify or optimize the latter scanning by use of the former scanning.

Therefore, the known scanner cannot finish the repair by itself, and furthermore, the complete scanning operation and the repair process cannot be finished unless cooperating with the external computer. Their operation is complicated, and the scanning system is not conducive to both carry and use. In addition, the volume of the known scanner is huge. A complete scanning operation needs to cooperate with an externally-connected computer to be accomplished. The most of the known scanners does not support multi-scanning, which reduces the design flexibility of scanning function.

### SUMMARY OF THE INVENTION

A scope of the invention is to provide an independent scanning apparatus for modifying image data obtained by scanning.

Another scope of the invention is to provide an independent scanning method for modifying image data obtained by scanning with the independent scanning apparatus.

The independent scanning apparatus of the invention includes a casing, a sheet-feeding mechanism, a scanning device, a store module, and a processing module. The casing includes an inlet and an outlet. The sheet-feeding mechanism is disposed in the casing for transporting an object through the inlet and the outlet. The scanning device is disposed in the casing for scanning the object. The processing module is disposed in the casing and electrically connected to the sheet-feeding mechanism, the scanning device and the store module.

When the object enters the casing through the inlet and the independent scanning apparatus receives an actuation instruction, the sheet-feeding mechanism transport the object at a first speed from a first position toward the outlet and the scanning device starts to scan the object to generate first scanned image data which is then stored in the store module, and when the object arrives at a second position, the scanning device stops the scanning. The first scanned image data is then to be analyzed to generate modified image data by many ways.

In one of the ways, the processing module could analyze the first scanned image data, process the first scanned image data to generate modified image data according to a result of analyzing the first scanned image data, and stores the modified image data in the store module. In addition, the processing module performs a white balance process or a color balance process or both thereof on the first scanned image data to generate the modified image data according to the result of analyzing the first scanned image data.

In another of the ways, when the object arrives at the second position, it should be appreciated that the processing module may analyze the first scanned image data simultaneously with the process of scanning the object, but not limited to. Then the sheet-feeding mechanism starts to transport the object toward the inlet so that the scanning device scans the object at a second speed to generate second scanned image data. The processing module processes the second scanned image data to generate modified image data according to a result of analyzing the first scanned image data, and stores the modified image data in the store module. In preferred embodiment, the processing module may modify the second scanned image data when scanning the object at the second speed.

In another of the ways, the sheet-feeding mechanism transports the object from the second position toward the inlet back to the first position, the sheet-feeding mechanism then transports the object at a second speed toward the outlet, and the scanning device scans the object to generate second scanned image data. The processing module analyzes the first scanned image data, processes the second scanned image data to generate modified image data according to a result of analyzing the first scanned image data, and stores the modified image data in the store module.

Obviously, the independent scanning apparatus of the invention itself has the functions of independently scanning and modifying image data without cooperation with external devices and supporting multi-scanning, so it is conducive to carry and operation. Furthermore, the independent scanning apparatus of the invention is equipped with the store module capable of being connected to external store media, for example memory cards. A user could therefore take out the modified image data stored in the store module through the external store media from the independent scanning apparatus and carry them along.

Therefore, compared to the scanning system of the prior art, the independent scanning apparatus and the independent scanning method of the invention have the advantages of independently scanning, supporting multi-scanning, small volume, simple operation, and easily carry and spread processed data. Furthermore, the independent scanning apparatus of the invention could still be treated as a scanner of an external processing apparatus (such as a personal computer), and it is therefore multi-functional.

The advantage and spirit of the invention may be understood by the following recitations together with the appended drawings.

### BRIEF DESCRIPTION OF THE APPENDED DRAWINGS

FIG. 1 is a schematic diagram illustrating an independent scanning apparatus according to a preferred embodiment.

FIG. 2 is a cross section of the independent scanning apparatus in FIG. 1.

FIG. 3 is a flow chart of an independent scanning method according to the preferred embodiment.

FIG. 4 is a schematic diagram illustrating the image configuration of a paper.

FIG. 5 is a schematic diagram illustrating the division of the first scanned image data.

FIG. 6 is a flow chart of an independent scanning method according to another preferred embodiment.

FIG. 7 is a flow chart of an independent scanning method according to another preferred embodiment.

### DETAILED DESCRIPTION OF THE INVENTION

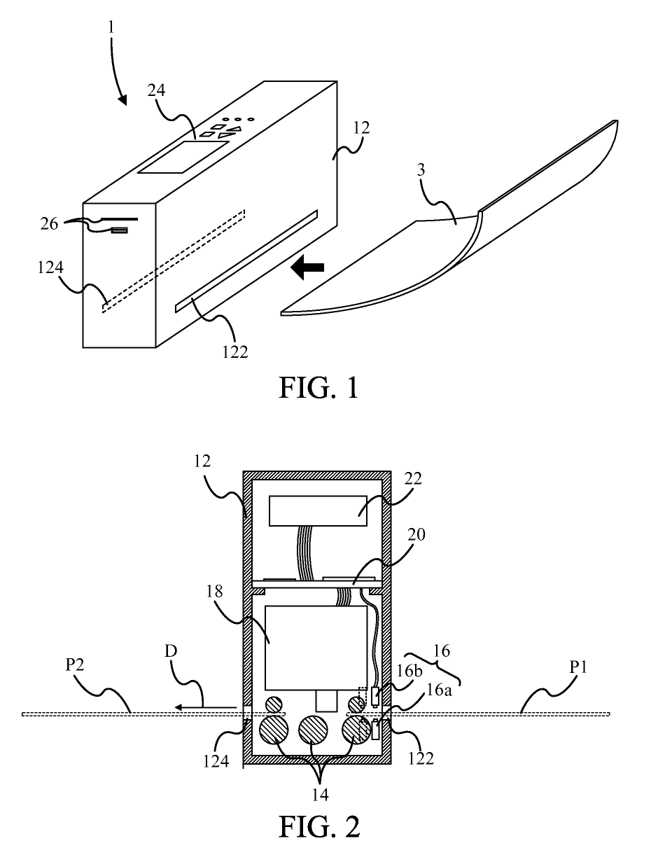

Please refer to FIG. 1 and FIG. 2. FIG. 1 is a schematic diagram illustrating an independent scanning apparatus 1 according to a preferred embodiment. FIG. 2 is a cross section of the independent scanning apparatus 1 in FIG. 1. The independent scanning apparatus 1 of the invention includes a casing 12, a sheet-feeding mechanism 14, a sensing device 16, a scanning device 18, a processing module 20, a store module 22, and a control panel 24.

The casing 12 includes an inlet 122 and an outlet 124 (whose locations are shown by dashed lines in FIG. 1). The sheet-feeding mechanism 14 primarily consists of rollers, support parts, and connection parts. The sheet-feeding mechanism 14 is disposed in the casing 12 for transporting an object to be scanned (such as paper 3) through and between the inlet 122 and the outlet 124; that is, the paper 3 moves along linear direction D through and between the inlet 122 and the outlet 124. The sensing device 16 is an optical sensing device disposed in the casing 12 between the sheet-feeding mechanism 14 and the inlet 122. The sensing device 16 includes a light-emitting port 16a and a light-receiving port 16b correspondingly disposed. The sensing device 16 detects whether light interruption occurs to determine whether the paper 3 is in the detectable range thereof. The scanning device 18 scans the paper 3 through a charge coupled device (CCD), a contact image sensor (CIS) or other devices capable of generating electronic signals responding to an image. The processing module 20 is electrically connected to the sheet-feeding mechanism 14, the sensing device 16, the scanning device 18, the store module 22, and the control panel 24. The processing 20 directly processes the scanned data by the scanning device 18 and directly stores the result of the processing in the store module 22. The control panel 24 is disposed on the casing 12 for providing an input interface for a user to easily operate the function selection and the function setting.

When the paper 3 enters the casing 12 through the inlet 122 to be in the detectable range of the sensing device 16, the sensing device 16 detects the paper 3 to activate the processing module 20 (or namely the processing module 20 receives an actuation instruction) to control the sheet-feeding mechanism 14 to start transporting the paper 3 at a first speed from the inlet 122; i.e. the paper 3 (not shown in FIG. 2) is transported from the first position P1 (shown by dashed lines in FIG. 2) to the outlet 124. At the same time, the scanning device 18 starts scanning the paper 3 to generate first scanned image data. When the paper 3 is transported to the outlet 124 (or the paper 3 is transported to the second position P2), the scanning device 18 stops the scanning. Therein, the processing module 20 analyzes the first scanned image data and stores the first scanned image data in the store module 22.

It is added that according to the preferred embodiment, as shown in FIG. 2, there is a short distance between the sensing device 16 and the sheet-feeding mechanism 14. When the sensing device 16 is to detect the paper 3 so that the processing module 20 is activated to control the rollers of the sheet-feeding mechanism 14 to roll, the paper 3 may be actually not held by the sheet-feeding mechanism 14; i.e. the paper 3 may not be at the first position P1. In this case, some stress-sensing devices could be disposed on the rollers of the sheet-feeding mechanism 14 (on the roller surfaces or the rotation shafts of the rollers), so as to detect whether the rollers has held the paper 3 (e.g. deformation stresses on the roller surfaces occur by directly contacting the paper 3, or deformation stresses on the rotation shafts occur by holding the paper 3) and accordingly confirm or estimate whether the paper 3 is at the first position P1.

Furthermore, the above activation could be the signal generated by the sensing device 16 detecting the paper 3, or be performed by the user inputting the selection through the control panel 24 (e.g. pushing an actuation button). In other words, the signal is the actuation instruction received by the independent scanning apparatus 1 so that the sheet-feeding mechanism 14 proceeds to the transport process. In practice application, unless the actuation button is pushed and the sensing device 16 generates the signal, the actuation instruction could not be achieved so that the sheet-feeding mechanism 14 proceeds to the transport process.

In addition, the first position P1 is not limited to the position as the sheet-feeding mechanism 14 holds the paper 3. The first position P1 could be the position as the sheet-feeding mechanism 14 holds the paper 3 and transports it in a short distance for a better holding situation. The above short distance (between the sensing device 16 and the sheet-feeding mechanism 14) could be reduced according to the disposition of the sensing device 16, even reduced to be ignored so that the above stress-sensing devices could be omitted. For example, a release space could be formed on/between the rollers (along the direction perpendicular to the paper surface of FIG. 2) for disposing the sensing device 16 therein (shown by the dashed lines beside the sensing device 16 in FIG. 2), so that the detectable range of the sensing device 16 could be close to, even overlap with the holding position where the sheet-feeding mechanism 14 hold the paper 3.

According to the preferred embodiment, when the paper 3 is at the second position P2, the paper 3 is far away from the detectable range of the sensing device 16. Therefore, the sensing device 16 activates the processing module 20 to control the sheet-feeding mechanism 14 to transport the paper 3 in a predetermined distance so that the paper 3 could be correctly at or beyond the second position P2. The distance is usually the range of physical transport of the rollers of the sheet-feeding mechanism 14. The purpose is to ensure that the image on the paper 3 has been scanned completely by the scanning device 18. The distance could also be set by the user through the control panel 24 (including display screen/touch panel, functional buttons, and indication lamps) so as to achieve customization, which is similar to the setting of the second position P2. The setting is more useful especially for the case that the user needs only part of the image on the paper 3 to be processed. Based on the above cause, if there are more sensing devices 16 disposed, the actual position of the paper 3 could be determined by the detection status of the sensing devices 16. Even in this case, the user could still set the second position P2, which does not conflict with the confirmation of the actual position of the paper 3 through the plurality of sensing devices 16.

It is added that the paper 3 transported by the sheet-feeding mechanism 14 toward the outlet 124 could be transported out of the casing 12 through the outlet 124 or be held at the second position P2 to avoid falling for the user to easily take the paper 3 out. Alternatively, the paper 3 could stop at the second position P2 and then be transported toward the inlet 122 back to the first position P1 for the user to easily take the paper 3 from the inlet 122. The above design is conducive to the use selection of the user under different operation environments. Therein, when the paper 3 is back to the first position P1 and the inlet 122 becomes the exit, whether the paper 3 is at the first position P1 could be determined through the sensing device 16, whose mechanism is described above and will not be described.

In addition, in the require for multi-scanning, when the sheet-feeding mechanism 14 transports the paper 3 from the second position P2 toward the inlet 122, the scanning device 18 could scan the paper 3 at a second speed to generate second scanned image data; alternatively, after the paper 3 is transported by the sheet-feeding mechanism 14 from the second position P2 toward the inlet 122 back to the first position P1, the sheet-feeding mechanism 14 transports the paper 3 again at the second speed toward the outlet 124, and the scanning device 18 scans the paper 3 to generate the second scanned image data.

It is added that when the paper 3 is transported from the first position P1 to the second position P2 at the first time, passage parameters of transporting the paper 3 by the sheet-feeding mechanism 14 have been recorded; when the sheet-feeding mechanism 14 transports the paper 3 reversely, the paper 3 could be transported precisely from the second position P2 back to the first position P1 according to the recorded passage parameters. In other words, according to the passage parameters, the size data of the paper 3 could be determined, at least the length of the paper 3 along the transport direction (i.e. the above-mentioned linear direction D). Therein, the estimation of the length of the paper 3 may need to involve the distance between the sensing device 16 and the sheet-feeding mechanism 14. In addition, the passage parameters could include transport time, transport speed (i.e. the first speed, e.g. presented in current) or revolutions of rollers and be directly stored in the processing module 20. The processing module 20 controls the sheet-feeding mechanism 14 to reversely transport the paper 3 according to the passage parameters. The passage parameters could be recorded directly in the circuit of the sheet-feeding mechanism 14 (e.g. counting circuit which accumulates the revolutions of the rollers and counts down the accumulated revolutions for reversely transporting). The accumulation of the revolutions of the rollers could be performed together with limit switches.

Regarding the second transport (at the second speed), it depends on the function selected by a user whether the paper 3 is to be stopped at the first position P1 or the second position P2; that is, the independent scanning apparatus 1 of the invention could provide operation of multi-scanning the same image to support various requirement of scanning, especially in the field of processing scanned image, which increases the flexibility of processing program. It is noticed that when the size of the paper 3 is known, the size of the paper 3 could be determined without the sensing device 16 and the sensing device 16 could therefore be skipped. The independent scanning apparatus 1 could transport the paper 3 through and between the first position P1 and the second position P2 precisely only by controlling the revolutions of the rollers.

It is added more that according to the preferred embodiment, the sensing device 16 is an interruption optical sensing device whose light-emitting port and light-receiving port are disposed opposite and the paper 3 could pass between. However, the invention is not limited to this. In practice application, the light-emitting port 16a and the light-receiving port of the sensing device 16 could be disposed at the same side for detecting the reflected light (e.g. infrared ray emitted by the light-emitting port 16a) from the surface of the paper 3. Of course, the sensing device 16 in the preferred embodiment could be replaced with mechanical switches, for example limit switches, which are triggered when the paper 3 passes by. Furthermore, the inlet 122 and the outlet 124 could be alternatively disposed at the same side of the casing 12, so the paper 3 could be in/out at the same side so that the required operation space could be further reduced. In this case, the transport path of the paper 3 becomes a curve direction by disposing and arranging the rollers of the sheet-feeding mechanism 14.

According to the preferred embodiment, the store module 22 could be a single built-in store module, e.g. hard disk or flash memory. If the built-in store module is a flash memory, it could be integrated within the processing module 20. Additionally, the independent scanning apparatus 1 further includes an interface 26 for transmitting the data stored in the store module 22 to an external portable store module (e.g. various memory cards or USB portable disks) connected to the interface 26. Of course, the independent scanning apparatus 1 could directly select the connected external portable store module as the medium for storing data. In other words, in practice application, the store module 22 of the independent scanning apparatus 1 could include simply a store medium connection interface (similar to the interface 26 shown in FIG. 1) disposed on the casing 12. The store medium connection interface is connected to the external portable store module externally and is also connected to the processing module 20 internally.

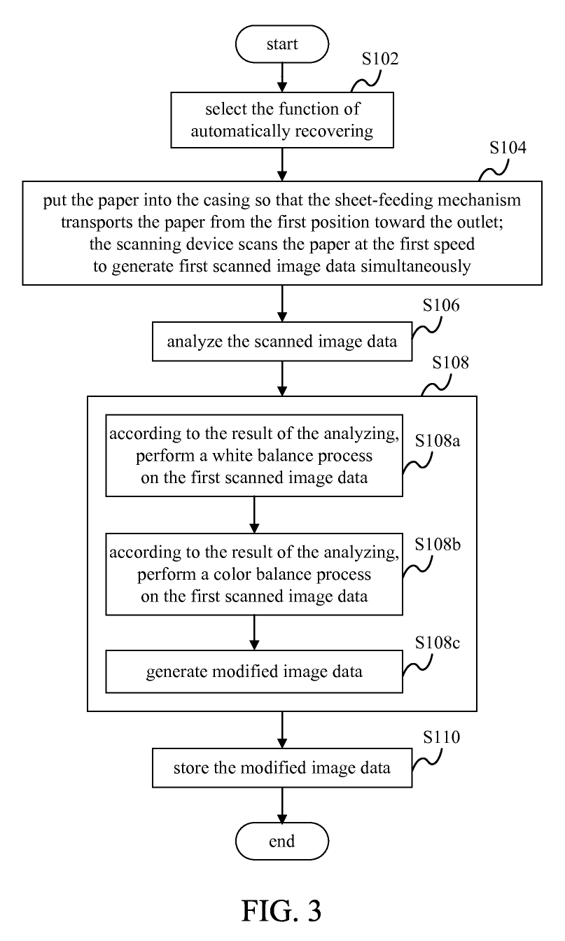

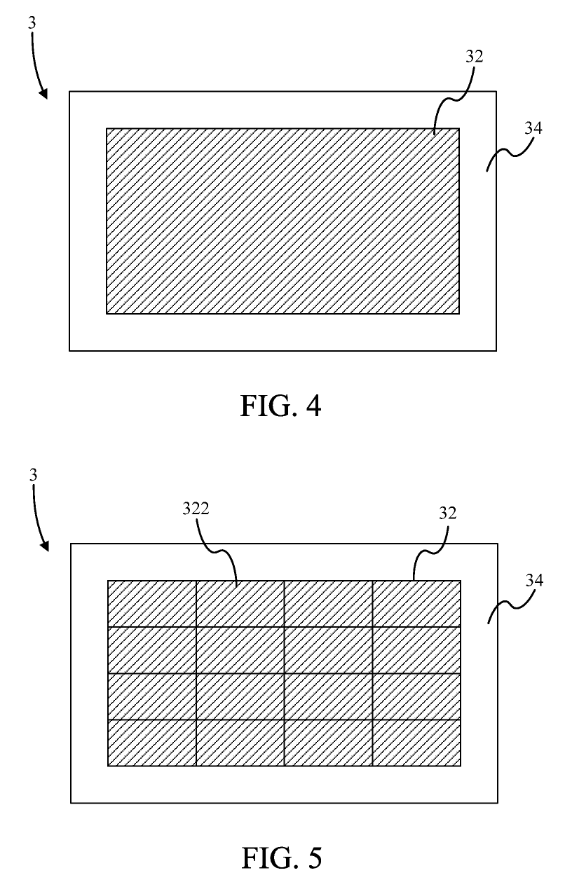

Please refer to FIG. 3. FIG. 3 is a flow chart of an independent scanning method according to another preferred embodiment. The independent scanning method of the invention is realized by the independent scanning apparatus of the invention. For an example of the independent scanning apparatus 1 shown in FIGS. 1 and 2, the independent scanning method of the invention is applied to the application of color recovery. If the application is to recover the image on the paper 3 automatically, the independent scanning method of the invention includes the following steps. The image configuration of the paper is shown as in FIG. 4. The middle oblique area is defined as an image area 32, and the surrounding non-image area is defined as a boundary area 34, whose four rims are not limited to the same.

First, the user selects the function of automatically recovering image through the control panel 24; i.e. the independent scanning apparatus 1 enters an image modification mode, as shown by the step S102. Then, the paper 3 (e.g. an old photo) is turned with the image thereon upward and is put into the casing 12 through the inlet 122 until the sensing device 16 detects the paper 3. The processing module 20 is activated to control the sheet-feeding mechanism 14 to start transporting the paper 3 at the first speed from the first position P1 toward the outlet 124, and the scanning device 18 scanning the paper 3 simultaneously to generate first scanned image data, as shown by the step S104. When the paper 3 arrives at the second position P2, the scanning device 18 stops the scanning. The generated first scanned image data could be stored in the store module 22 (including being stored in an external portable store module if the external portable store module exists). The first scanned image data could be 16-bit image data or image data with other image resolution, which depends on demand and could be selected by the user through the control panel 24.

Then, when the paper 3 is transported to the outlet 124 (or the paper 3 is transported to the second position P2), the scanning device 18 stops the scanning. The whole first scanned image data is stored completely. The processing module 20 analyzes the first scanned image data, as shown by the step S106. The analyzing could be performed as the scanning device 18 is scanning or after the whole paper 3 has been scanned; even depending on the analysis kinds, the analyzing could also be performed respectively at the scanning and after the scanning. The result of the analyzing could be stored in the store module 22 (including being stored in an external portable store module if the external portable store module exists). In regard to the disposition that the paper 3 is transported to or beyond the second position P2 for further taking out, it is shown as above and will not be described.

The above result of the analyzing includes pixel gray level values, location data of divided sub-images, pixel gray level variation values of the divided sub-images relative to the first scanned image data, and other data required for modifying image. According to the result of the analyzing, the processing module 20 performs various image modification processes on the first scanned image data to generate modified image data, as shown by the step S108.

In regard to the above pixel gray level values relative to the first scanned image data, the processing module 20 could perform a white balance process on the first scanned image data according to them, as shown by the step S108a. For example, the pixel gray level values could be presented by the distribution of counts of pixels to gray levels. When the pixels are accumulated up to a certain proportion (e.g. 5%), the pixel gray level values of the pixels within the accumulated pixels (i.e. 5% of all the pixels) are replaced with a lower input gray level value; when the pixel counts are accumulated up to a certain proportion (e.g. 95%), the pixel gray level values of the pixels out of the accumulated pixels (i.e. 95% of all the pixels) are replaced with an upper input gray level value. Every pixel gray level value of the other pixels is replaced with a substitutive gray level value calculated in proportion (e.g. the upper input gray level value and the lower input gray level value corresponding to the gray level value relative to the upper

accumulated limit (95%) and the gray level value relative to the lower accumulated limit (5%) respectively).

In regard to the above location data of the divided sub-images and the pixel gray level variation values of the divided sub-images relative to the first scanned image data, the processing module 20 could perform a color balance process on the first scanned image data according to them, as shown by the step S108b. For example, the division of the first scanned image data is schematically shown in FIG. 5. The sixteen divided sub-images 322 (notated by one for example) are arranged in the order of the pixel gray level variation values. A certain proportion of the divided sub-images whose pixel gray level variation values are larger are selected as the samples for calculating the average gray level values relative to color channels. Further based on a power function or other functions, the pixel gray level values are renewedly calculated by varying the parameters of the function. The average gray level values relative to the color channels are then renewedly calculated according to the renewed pixel gray level values. The above process is performed repeatedly until the renewed average gray level values relative to the color channels are substantially equal or the difference thereof is within an allowable range. The determined parameters are used with the above function to modify the pixels of the first scanned image data. It is added that if the color balance process is performed after the white balance process, the subject of the color balance process could be the image data modified with the white balance process.

After the steps S108a and S108b, the first scanned image data has been converted to a modified image data, as shown by the step S108c. The modified image data are stored in the store module 22 (including being stored in an external portable store module if the external portable store module exists), as shown by the step S110. It is noticed that the modification on the first scanned image data is not limited to the above, but depends on the image recovery software built in the independent scanning apparatus 1. In general, besides the white balance process, the color balance process is also performed on the whole (or partial) image to obtain the modified image whose color quality is better than the original image on the paper 3 to be the output of the function of automatically recovering image. In addition, the resolution of the modified image data is equal to that of the first scanned image data in principle, i.e. 16-bit image data. However, the invention is not limited to this. For example, after the step S108, the modified image data are converted to image data with other bit format, e.g. common 8-bit image data, before performing the step S110.

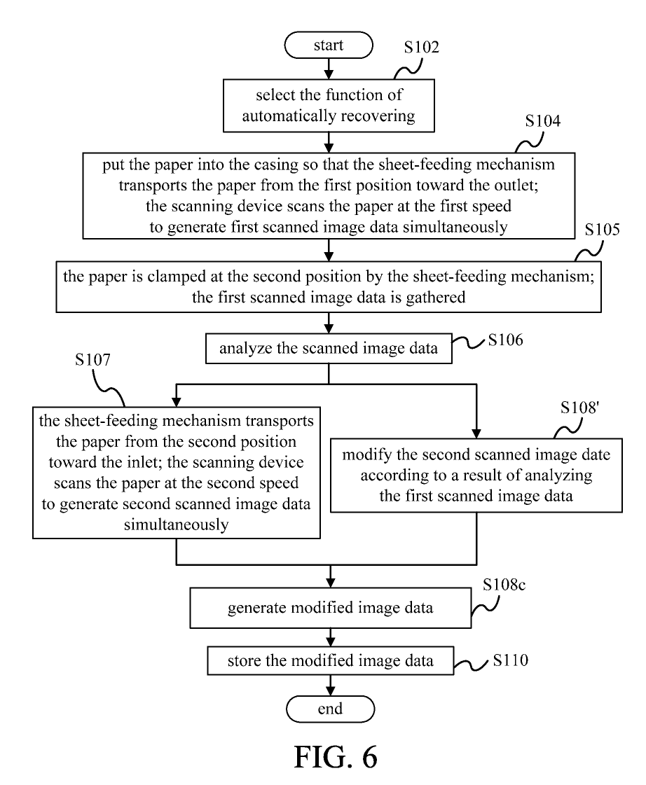

Please refer to FIG. 6. FIG. 6 is a flow chart of an independent scanning method according to another preferred embodiment. The independent scanning method of this preferred embodiment is also realized by the independent scanning apparatus of the invention. For an example of the independent scanning apparatus 1 shown in FIGS. 1 and 2, the independent scanning method is applied to the application of color recovery. If the application is to recover the image on the paper 3 automatically, the independent scanning method shown in FIG. 6 includes the following steps.

The flow chart shown in FIG. 6 is similar to the flow chart shown in FIG. 3. The difference is that the independent scanning method shown in FIG. 6 further includes clamping the paper 3 at the second position P2 by the sheet-feeding mechanism 14 and simultaneously gathering the first scanned image data, as shown by the step S105, and includes transporting the paper 3 at the second speed by the sheet-feeding mechanism 14 from the second position P2 toward the inlet 122 and scanning the paper 3 by the scanning device 18 to generate second scanned image data, as shown by the step S107. Furthermore, during the step S107, the modification could be performed simultaneously on the second scanned image data which is continually generated by the step S107, as shown by the step S108′. It is also noticed that the step S108′ could be alternatively performed after the step S107, which depends on the image recovery program, and the details of the modification of the step S108′ could also be same as the step S108a and S108b in FIG. 3. The foregoing and the following steps could refer to FIG. 3, and it will not be described more.

Therefore, the object of the step S108 shown in FIG. 3 is replaced with the second scanned image data from the first scanned image data. Based on the feature of multi-scanning, the first scanning (the step S104) could be performed for provide a function of preview, so the first speed could be set to be a faster speed; while the second scanning (the step S107) is performed to scan the required image area normally, so the second speed is usually slower than the first speed. Of course, if the first speed and the second speed are set to be the same, the analysis based on the first scanning could provide more modification information. However, the invention is not limited to this, and the design of the first speed and the second speed depends on the applied image recovery program. In addition, in some applications, the first scanning does not need to be performed in high density whole on the all area of the paper 3 (including the image area 32 and the boundary area 34) but on some (default) areas (e.g. the central portion of the image area 32 which could be changed afterwards by the user through the control panel 24), so the first speed is usually faster than the second speed.

In addition, the size data of the paper 3 which is determined according to the transport of the paper 3 from the first position P1 to the second position P2 could be the reference for the second scanning or the image processing after the second scanning, for example the setting of the boundary and the image cut for the second scanning. In an embodiment, only selecting the scanned image by a certain aspect ration in the second scanning is conducive to simplifying the modification process of the step S108. The above-mentioned size data are conducive to the achievement of the purpose.

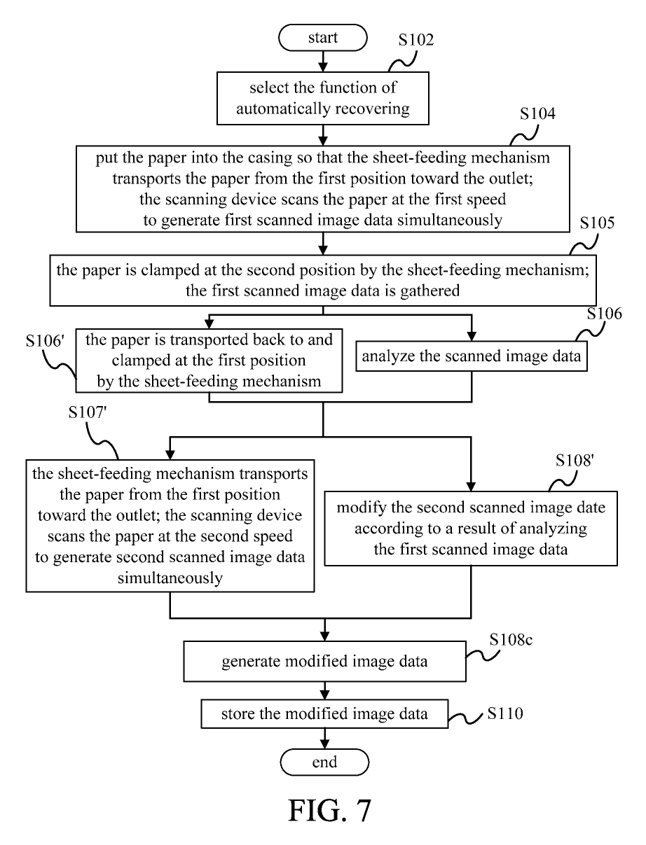

Please refer to FIG. 7. FIG. 7 is a flow chart of an independent scanning method according to another preferred embodiment. The independent scanning method of this preferred embodiment is also realized by the independent scanning apparatus of the invention and is similar to the independent scanning method shown in FIG. 6. The difference is that the second scanning is not performed when the paper 3 is transported from the second position P2 back to the first position P1 (as shown by the step S106′) but when the paper 3 is transported again by the sheet-feeding mechanism 14 from the first position P1 toward the outlet 124 (as shown by the step S107′). Similar to the second scanning case shown in FIG. 6, during the step S107′, the modification could be performed simultaneously on the second scanned image data which is continually generated by the step S107′, as shown by the step S108′. The description of the step S108′ in FIG. 7 is same as the description of the step S108′ in FIG. 6, and it will not be described here. Obviously, the independent scanning apparatus and the independent scanning method of the invention provide quite flexibility in multi-scanning, which is conducive to the development of independent image modification program.

As discussed above, the independent scanning apparatus and the independent scanning method of the invention could directly process the scanned image data and store the processed data in the store module. It is conducive to carry and operation. In addition, the independent scanning apparatus of the invention provides the control panel through which the user could proceed to simple image processes (e.g. color weakness, color inverse, capture for a specific area, and background setting).

With the example and explanations above, the features and spirits of the invention will be hopefully well described. Those skilled in the art will readily observe that numerous modifications and alterations of the device may be made while retaining the features and spirit of the invention. Accordingly, the above disclosure should be construed as limited only by the metes and bounds of the appended claims.

What is claimed is:

1. An independent scanning apparatus, comprising:
a casing, comprising an inlet and an outlet;
a sheet-feeding mechanism, disposed in the casing for transporting an object through the inlet and the outlet;
a scanning device, disposed in the casing for scanning the object;
a store module; and
a processing module, disposed in the casing and electrically connected to the sheet-feeding mechanism, the scanning device and the store module;
wherein when the object enters the casing through the inlet and the independent scanning apparatus receives an actuation instruction, the sheet-feeding mechanism transport the object at a first speed from a first position toward the outlet and the scanning device starts to scan the object to generate first scanned image data which is then stored in the store module, and when the object arrives at a second position, the scanning device stops the scanning.

2. The independent scanning apparatus of claim 1, wherein the processing module analyzes the first scanned image data, processes the first scanned image data to generate modified image data according to a result of analyzing the first scanned image data, and stores the modified image data in the store module.

3. The independent scanning apparatus of claim 2, wherein the processing module performs one of a white balance process and a color balance process on the first scanned image data to generate the modified image data according to the result of analyzing the first scanned image data.

4. The independent scanning apparatus of claim 1, further comprising a sensing device disposed in the casing and between the sheet-feeding mechanism and the inlet, wherein the actuation instruction represents that the sensing device has detected the object.

5. The independent scanning apparatus of claim 1, wherein when the sheet-feeding mechanism transports the object from the first position to the second position, the processing module determines size data relative to the object.

6. The independent scanning apparatus of claim 1, wherein when the object arrives at the second position, the sheet-feeding mechanism starts to transport the object toward the inlet so that the scanning device scans the object at a second speed to generate second scanned image data.

7. The independent scanning apparatus of claim 6, wherein the processing module analyzes the first scanned image data, processes the second scanned image data to generate modified image data according to a result of analyzing the first scanned image data, and stores the modified image data in the store module.

8. The independent scanning apparatus of claim 1, wherein the sheet-feeding mechanism transports the object from the second position toward the inlet to the first position, the sheet-feeding mechanism then transports the object at a second speed toward the outlet, and the scanning device scans the object to generate second scanned image data.

9. The independent scanning apparatus of claim 8, wherein the processing module analyzes the first scanned image data, processes the second scanned image data to generate modified image data according to a result of analyzing the first scanned image data, and stores the modified image data in the store module.

10. The independent scanning apparatus of claim 1, wherein the store module comprises a connection interface for connecting an external portable store module.

11. An independent scanning method for scanning an object by an independent scanning apparatus, the independent scanning apparatus comprising a casing, a sheet-feeding mechanism, a scanning device, a store module and a processing module, the casing comprising an inlet and an outlet, the processing module being electrically connected to the sheet-feeding mechanism, the scanning device and the store module, said independent scanning method comprising steps of:
(a) entering the object in the casing through the inlet;
(b) transporting and scanning the object at a first speed from a first position toward the outlet to generate first scanned image data when receiving an actuation instruction;
(c) storing the first scanned image data in the store module; and
(d) stopping the scanning when the object arrives at a second position.

12. The independent scanning method of claim 11, further comprising:
analyzing the first scanned image data, processing the first scanned image data to generate modified image data according to a result of analyzing the first scanned image data, and storing the modified image data in the store module.

13. The independent scanning method of claim 12, wherein the processing module performs one of a white balance process and a color balance process on the first scanned image data to generate the modified image data according to the result of analyzing the first scanned image data.

14. The independent scanning method of claim 11, the independent scanning apparatus comprising a sensing device, wherein in the step (b), the actuation instruction represents that the sensing device has detected the object.

15. The independent scanning method of claim 11, further comprising:
determining size data relative to the object when the sheet-feeding mechanism transports the object from the first position to the second position.

16. The independent scanning method of claim 11, further comprising:
transporting and scanning the object toward the inlet at a second speed to generate second scanned image data when the object arrives at the second position.

17. The independent scanning method of claim 16, further comprising:
analyzing the first scanned image data, processing the second scanned image data to generate modified image data according to a result of analyzing the first scanned image data, and storing the modified image data in the store module.

18. The independent scanning method of claim 11, further comprising:
(a1) transporting the object from the second position toward the inlet to the first position; and
(a2) after the step (a1), transporting and scanning the object at a second speed toward the outlet to generate second scanned image data.

19. The independent scanning method of claim 18, further comprising:
analyzing the first scanned image data, processing the second scanned image data to generate modified image data according to a result of analyzing the first scanned image data, and storing the modified image data in the store module.

20. The independent scanning method of claim 11, further comprising:
before the step (b), the independent scanning apparatus entering an image modification mode.
